(19) United States
(12) Patent Application Publication
(10) Pub. No.: US 2026/0353052 A1
(43) Pub. Date: Nov. 5, 2026

(54) DATA COMMUNICATION SYSTEM, CENTER DEVICE, VEHICULAR DEVICE, DATA PROCESSING METHOD, AND DATA PROCESSING PROGRAM

(71) Applicant: DENSO CORPORATION, Kariya-city (JP)

(72) Inventors: Mamoru HOSOKAWA, Kariya-city (JP); Kensho Taki, Kariya-city (JP); Shinichi Koike, Kariya-city (JP)

(21) Appl. No.: 19/709,834

(22) Filed: Jun. 16, 2026

Related U.S. Application Data
(63) Continuation of application No. PCT/JP2024/037398, filed on Oct. 21, 2024.

(30) Foreign Application Priority Data
Dec. 28, 2023 (JP) 2023-222246

(51) Int. Cl. H04W 4/40; G07C 5/00

(52) U.S. Cl. CPC H04W 4/40; G07C 5/008

(57) ABSTRACT

A center device generates multiple trigger conditions for detecting a given scene of a vehicle, generates multiple collection data lists respectively corresponding to the trigger conditions, generates a switching condition and/or priority corresponding to each trigger condition and each collection data list, and transmits the multiple trigger conditions, the multiple collection data lists, and the switching condition and/or the priority a vehicular device. The vehicular device switches a trigger condition to be used according to the switching condition and/or priority, performs a trigger condition determination according to the trigger condition, switches the collection data list to be used according to the switching condition and/or the priority, generates the collection data and transmits the collection data to the center device.

### CROSS REFERENCE TO RELATED APPLICATION

This application is a continuation application of International Patent Application No. PCT/JP2024/037398 filed on Oct. 21, 2024, which designated the U.S. and claims the benefit of priority from Japanese Patent Application No. 2023-222246 filed on Dec. 28, 2023. The entire disclosures of all of the above applications are incorporated herein by reference.

### TECHNICAL FIELD

The present disclosure relates to a data communication system, a center device, a vehicular device, a data processing method, and a data processing program.

### BACKGROUND

There is provided a data communication system in which a center device collects vehicle data from an unspecified number of vehicles.

### SUMMARY

According to one aspect of the present disclosure, a center device and a vehicular device mounted on a vehicle are capable of data communication with each other. The center device may generate a plurality of trigger conditions for detecting a given scene of the vehicle, generate a plurality of collection data lists respectively corresponding to the plurality of trigger conditions, generate a switching condition and/or priority corresponding to each trigger condition and each collection data list, and deliver the plurality of trigger conditions, the plurality of collection data lists, and the switching condition and/or the priority a vehicular device. The vehicular device may acquire detection data required for a trigger condition determination, able to switch a trigger condition to be used according to the switching condition and/or priority, perform the trigger condition determination based on the detection data according to the trigger condition, able to switch the collection data list to be used according to the switching condition and/or the priority, generate the collection data based on a determination result of the trigger condition determination, and transmit the collection data to the center device.

According to another aspect of the present disclosure, a center device and a vehicular device mounted on a vehicle are capable of data communication with each other. The center device may generate a plurality of trigger conditions for detecting a given scene of the vehicle, generate a collection data list corresponding to the plurality of trigger conditions, generate a switching condition and/or priority corresponding to each trigger condition, deliver the plurality of trigger conditions and the collection data list to the vehicular device, deliver the switching condition and/or the priority to the vehicular device, and may acquire collection data indicated in the collection data list from the vehicular device. The vehicular device may acquire detection data required for a trigger condition determination, switch a trigger condition to be used according to the switching condition and/or the priority, perform the trigger condition determination based on the detection data according to the trigger condition, generate the collection data based on a determination result of the trigger condition determination, and transmit the collection data to the center device.

According to yet another aspect of the present disclosure, a center device and a vehicular device mounted on a vehicle are capable of data communication with each other. The center device may generate a trigger condition for detecting a given scene of the vehicle, generate a plurality of collection data lists corresponding to the trigger condition, generate a switching condition and/or priority corresponding to each collection data list, deliver the trigger condition and the plurality of collection data lists to the vehicular device, deliver the switching condition and/or the priority to the vehicular device, and acquire collection data indicated in the collection data list from the vehicular device. The vehicular device may acquire detection data required for a trigger condition determination, perform the trigger condition determination based on the detection data according to the trigger condition, switch a collection data list to be used according to the switching condition and/or the priority, generate the collection data based on a determination result of the trigger condition determination, and transmit the collection data to the center device.

### BRIEF DESCRIPTION OF DRAWINGS

Objects, features and advantages of the present disclosure will become apparent from the following detailed description made with reference to the accompanying drawings. In the drawings:

FIG. 1 is a functional block diagram illustrating an overall configuration of an embodiment;

FIG. 2 is a functional block diagram of a center device;

FIG. 3 is a functional block diagram of a vehicular device;

FIG. 4 is a functional block diagram of a controller unit of the center device;

FIG. 5 is a diagram illustrating a trigger condition file (prior to switching);

FIG. 6 is a diagram illustrating a collection data list file (prior to switching);

FIG. 7 is a diagram illustrating a trigger condition file (post switching);

FIG. 8 is a diagram illustrating a collection data list file (post switching);

FIG. 9 is a diagram illustrating a switching-condition-and-priority file;

FIG. 10 is a functional block diagram of a controller unit of the vehicular device;

FIG. 11 is a flowchart illustrating processes performed by the vehicular device;

FIG. 12 is a flowchart illustrating processes performed by the vehicular device;

FIG. 13 is a flowchart illustrating processes performed by the center device;

FIG. 14 is a diagram illustrating a flow of processes;

FIG. 15 is a flowchart illustrating processes performed by the vehicular device;

FIG. 16 is a flowchart illustrating processes performed by the vehicular device;

FIG. 17 is a flowchart illustrating processes performed by the center device; and

FIG. 18 a diagram illustrating a flow of processes.

### DETAILED DESCRIPTION

There is provided a data communication system in which a center device collects vehicle data from an unspecified number of vehicular devices by receiving the vehicle data transmitted from the vehicular devices mounted on the unspecified number of vehicles. For example, there is a technology for reducing a transmission frequency of access requests from vehicular devices to a center device and for reducing processing load of authentication for collecting vehicle data.

Users may experience dissatisfaction when using vehicles. An assumed technology for specifying user dissatisfaction may directly or indirectly specify user dissatisfaction. For example, when a Lane Tracing Assist (hereinafter referred to as LTA) function is active during highway driving, it is possible to directly determine that the user experiences dissatisfaction by determining that the user performs a steering operation to cancel the LTA function. For example, by determining that the user has refused to use an auto-parking function in response to a recommendation to use the auto-parking function at start of parking, it is possible to directly determine that the user experiences dissatisfaction. Furthermore, after improving the LTA function based on another user's request, it is possible to indirectly determine that the user experiences dissatisfaction by determining that the behavior of the LTA function logic during operation differs from the behavior of the improved LTA function logic. Given these circumstances, for example, there are needs for vehicle manufacturers and application development vendors to analyze scenes where users experience dissatisfaction and to improve vehicle functionalities.

In such cases, in order to analyze the scene where the user experienced dissatisfaction, a center device generates a trigger condition for detecting a scene where a user experiences dissatisfaction, and the center device collects from the vehicular device and analyzes such data as sensor values from sensors and control statuses of systems around the time the trigger condition is met. However, there is not necessarily just one trigger condition, and there may be cases where it is necessary to switch between multiple trigger conditions in order to efficiently improve vehicle functionality.

The present disclosure provides technology for flexibly switching between multiple trigger conditions for detecting a scene where a user feels dissatisfaction, thereby enabling efficient improvement to a vehicle functionality.

According to a first aspect of the present disclosure, in a data communication system, a center device and a vehicular device mounted on a vehicle are capable of data communication with each other. The center device includes: a trigger condition generator that generates a plurality of trigger conditions for detecting a given scene of the vehicle; a collection data list generator that generates a plurality of collection data lists corresponding to the plurality of trigger conditions, respectively; a switching information generator that generates a switching condition and/or priority corresponding to each trigger condition and each collection data list; a deliverer that delivers the plurality of trigger conditions and the plurality of collection data lists to the vehicular device, and delivers the switching condition and/or the priority to the vehicular device; and a data acquirer that acquires collection data indicated in the collection data list from the vehicular device. The vehicular device includes: a detection data acquirer that acquires detection data required for a trigger condition determination; a trigger condition determiner that is able to switch a trigger condition to be used according to the switching condition and/or the priority, and performs the trigger condition determination based on the detection data according to the trigger condition; a collection data generator that is able to switch a collection data list to be used according to the switching condition and/or the priority, and generates the collection data based on a determination result of the trigger condition determination; and a collection data transmitter that transmits the collection data to the center device.

According to a second aspect of the present disclosure, a center device is capable of data communication with a vehicular device mounted on a vehicle, wherein the vehicular device acquires detection data required for a trigger condition determination, is able to switch a trigger condition to be used according to a switching condition and/or priority, performs the trigger condition determination based on the detection data according to the trigger condition, is able to switch a collection data list to be used according to the switching condition and/or the priority, generates collection data based on a determination result of the trigger condition determination, transmits the collection data to the center device. The center device comprises: a trigger condition generator that generates a plurality of trigger conditions for detecting a given scene of the vehicle; a collection data list generator that generates a plurality of collection data lists corresponding to the plurality of trigger conditions, respectively; a switching information generator that generates the switching condition and/or priority corresponding to each trigger condition and each collection data list; a deliverer that delivers the plurality of trigger conditions and the plurality of collection data lists to the vehicular device, and delivers the switching condition and/or the priority to the vehicular device; and a data acquirer that acquires the collection data indicated in the collection data list from the vehicular device.

According to a third aspect of the present disclosure, a vehicular device is mounted on a vehicle and capable of data communication with a center device, wherein the center device generates a plurality of trigger conditions for detecting a given scene of the vehicle, generates a plurality of collection data lists corresponding to the plurality of trigger conditions, respectively, generates a switching condition and/or priority corresponding to each trigger condition and each collection data list, delivers the plurality of trigger conditions and the plurality of collection data lists to the vehicular device, delivers the switching condition and/or the priority to the vehicular device, and acquires collection data indicated in the collection data list from the vehicular device. The vehicular device comprises: a detection data acquirer that acquires detection data required for a trigger condition determination; a trigger condition determiner that is able to switch a trigger condition to be used according to the switching condition and/or the priority, and performs the trigger condition determination based on the detection data according to the trigger condition; a collection data generator that is able to switch a collection data list to be used according to the switching condition and/or the priority, and generates the collection data based on a determination result of the trigger condition determination; and a collection data transmitter that transmits the collection data to the center device.

According to a fourth aspect of the present disclosure, a data processing metho is executed in a data communication system in which a center device and a vehicular device mounted on a vehicle are capable of data communication with each other. The data processing method comprises executing in the center device: generating a plurality of trigger conditions for detecting a given scene of the vehicle; generating a plurality of collection data lists corresponding to the plurality of trigger conditions, respectively; generating a switching condition and/or priority corresponding to each trigger condition and each collection data list; delivering the plurality of trigger conditions and the plurality of collection data lists to the vehicular device, and delivering the switching condition and/or the priority to the vehicular device; and acquiring collection data indicated in the collection data list from the vehicular device. The data processing method further comprises executing in the vehicular device: acquiring detection data required for a trigger condition determination; switching a trigger condition to be used according to the switching condition and/or the priority, and performing the trigger condition determination based on the detection data according to the trigger condition; switching a collection data list to be used according to the switching condition and/or the priority, and generating the collection data based on a determination result of the trigger condition determination; and transmitting the collection data to the center device.

According to a fifth aspect of the present disclosure, a data processing method is executed in a center device capable of data communication with a vehicular device mounted on a vehicle, wherein the vehicular device acquires detection data required for a trigger condition determination, is able to switch a trigger condition to be used according to a switching condition and/or priority, performs the trigger condition determination based on the detection data according to the trigger condition, is able to switch a collection data list to be used according to the switching condition and/or the priority, generates collection data based on a determination result of the trigger condition determination, transmits the collection data to the center device, the data processing metho comprising executing in the center device: generating a plurality of trigger conditions for detecting a given scene of the vehicle; generating a plurality of collection data lists corresponding to the plurality of trigger conditions, respectively; generating the switching condition and/or priority corresponding to each trigger condition and each collection data list; delivering the plurality of trigger conditions and the plurality of collection data lists to the vehicular device, and delivering the switching condition and/or the priority to the vehicular device; and acquiring the collection data indicated in the collection data list from the vehicular device.

According to a sixth aspect of the present disclosure, a data processing method is executed in a vehicular device mounted on a vehicle and capable of data communication with a center device, wherein the center device generates a plurality of trigger conditions for detecting a given scene of the vehicle, generates a plurality of collection data lists corresponding to the plurality of trigger conditions, respectively, generates a switching condition and/or priority corresponding to each trigger condition and each collection data list, delivers the plurality of trigger conditions and the plurality of collection data lists to the vehicular device, delivers the switching condition and/or the priority to the vehicular device, and acquires collection data indicated in the collection data list from the vehicular device. The data processing method comprises executing in the vehicular device: acquiring detection data required for a trigger condition determination; switching a trigger condition to be used according to the switching condition and/or the priority, and performing the trigger condition determination based on the detection data according to the trigger condition; switching a collection data list to be used according to the switching condition and/or the priority, and generating the collection data based on a determination result of the trigger condition determination; and transmitting the collection data to the center device.

According to a seventh aspect of the present disclosure, a data processing program for a center device capable of data communication with a vehicular device mounted on a vehicle is provided, wherein the vehicular device acquires detection data required for a trigger condition determination, is able to switch a trigger condition to be used according to a switching condition and/or priority, performs the trigger condition determination based on the detection data according to the trigger condition, is able to switch a collection data list to be used according to the switching condition and/or the priority, generates collection data based on a determination result of the trigger condition determination, transmits the collection data to the center device. The data processing program causes the center device to execute: generating a plurality of trigger conditions for detecting a given scene of the vehicle; generating a plurality of collection data lists corresponding to the plurality of trigger conditions, respectively; generating the switching condition and/or priority corresponding to each trigger condition and each collection data list; delivering the plurality of trigger conditions and the plurality of collection data lists to the vehicular device, and delivering the switching condition and/or the priority to the vehicular device; and acquiring the collection data indicated in the collection data list from the vehicular device.

According to an eight aspect of the present disclosure, a data processing program for a vehicular device mounted on a vehicle and capable of data communication with a center device is provided, wherein the center device generates a plurality of trigger conditions for detecting a given scene of the vehicle, generates a plurality of collection data lists corresponding to the plurality of trigger conditions, respectively, generates a switching condition and/or priority corresponding to each trigger condition and each collection data list, delivers the plurality of trigger conditions and the plurality of collection data lists to the vehicular device, delivers the switching condition and/or the priority to the vehicular device, and acquires collection data indicated in the collection data list from the vehicular device. The data processing program causes the vehicular device to execute: acquiring detection data required for a trigger condition determination; switching a trigger condition to be used according to the switching condition and/or the priority, and performing the trigger condition determination based on the detection data according to the trigger condition; switching a collection data list to be used according to the switching condition and/or the priority, and generating the collection data based on a determination result of the trigger condition determination; and transmitting the collection data to the center device.

The center device generates the switching condition and/or the priority corresponding to each trigger condition and each collection data list, and the vehicular device is able to switch between the trigger conditions and between the collection data lists according to the switching condition and/or the priority and, generates the collection data based on a determination result of the trigger condition determination and transmits the collection data to the center device. It is possible to flexibly switch between multiple trigger conditions for detecting a scene where a user feels dissatisfaction, enabling efficient improvement to a vehicle functionality.

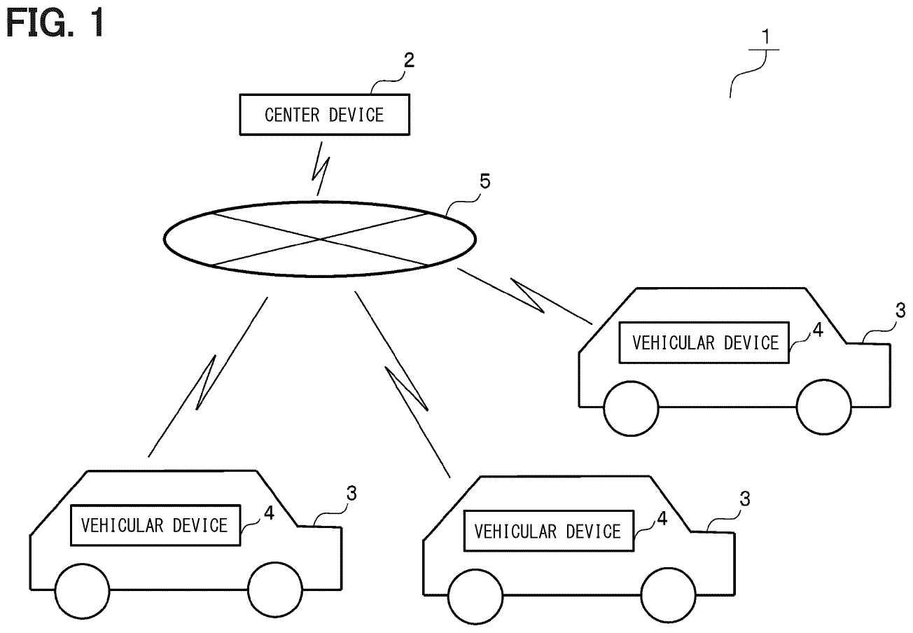

Hereinafter, embodiments will be described with reference to the drawings. As shown in FIG. 1, a data communication system 1 is configured such that a center device 2 and vehicular devices 4 individually mounted on multiple vehicles 3 are capable of data communication via a wide-area wireless communication network 5.

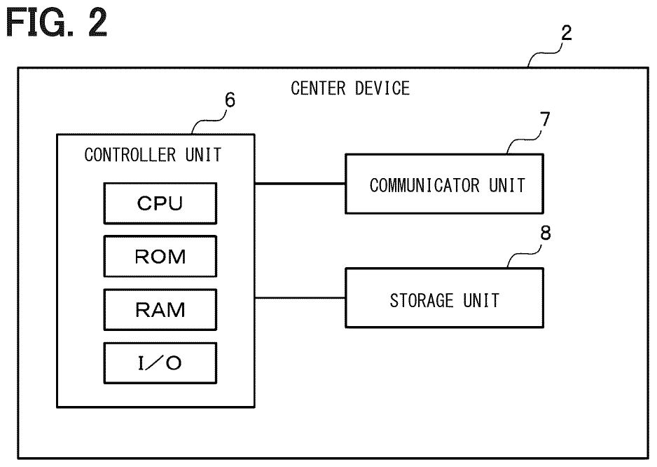

As shown in FIG. 2, the center device 2 includes a controller unit 6, a communicator unit 7, and a storage unit 8. The controller unit 6 includes, as its main component, a microcomputer (hereinafter referred to as a microcontroller) including a CPU, ROM, RAM, and I/O and executes controls via software processing by the CPU executing a computer program stored in a non-transitory tangible storage medium, and hardware processing by a dedicated electronic circuit, thereby controlling operations of the center device 2. A method corresponding to the computer program is executed by executing the computer program. The number of microcontrollers in the controller unit 6 may be one or more. The communicator unit 7 controls the data communication with the multiple vehicular devices 4 via the wide-area wireless communication network 5. The storage unit 8 stores various data.

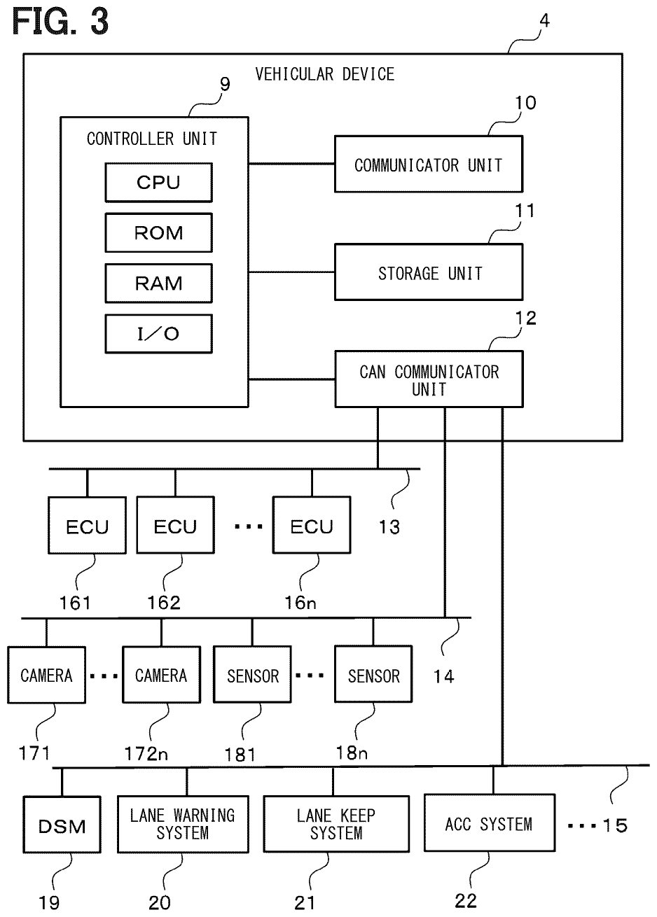

As shown in FIG. 3, the vehicular device 4 includes a controller unit 9, a communicator unit 10, a storage unit 11, and a CAN (Controller Area Network) communicator unit 12. The controller unit 9 includes, as its main component, a microcontroller including a CPU, ROM, RAM, and I/O, and executes controls via software processing by the CPU executing a computer program stored in a non-transitory tangible storage medium, and hardware processing by a dedicated electronic circuit, thereby controlling operations of the vehicular device 4. A method corresponding to the computer program is executed by executing the computer program. The number of microcontrollers in the controller unit 9 may be one or more. The communicator unit 10 controls the data communication with the center device 2 via the wide-area wireless communication network 5. The storage unit 11 stores various data.

The CAN communicator unit 12 connects to CAN buses 13 to 15. The CAN communicator unit 12 is connected to multiple ECUs 161 to 16n via the CAN bus 13 in a data communicable manner. The multiple ECUs 161 to 16n include, for example, an engine ECU for engine control, an accelerator ECU for accelerator control, a brake ECU for brake control, a steering ECU for steering control, a meter ECU for meter control, and a navigation ECU for navigation control. For example, the accelerator ECU transmits data indicating accelerator opening as the detection data to the CAN communicator unit 12. For example, the brake ECU transmits data indicating a brake pedal operation amount as the detection data to the CAN communicator unit 12. For example, the steering ECU transmits data indicating the angular velocity of the steering wheel as the detection data to the CAN communicator unit 12. For example, the navigation ECU transmits data indicating the latitude and longitude as the detection data to the CAN communicator unit 12. ECUs of the multiple ECUs 161 to 16n are connected to the same single bus for each system. For example, ECUs for a ADAS (Advanced Driving Assistant System) are connected to a same single bus, ECUs for a body system are connected to a same single bus, ECUs for a chassis system are connected to a same single bus.

The CAN communicator unit 12 is connected via the CAN bus 14 to multiple cameras 171 to 17n and multiple sensors 181 to 18n in a data communicable manner. The multiple cameras 171 to 17n include, for example, a front camera for imaging an area forward of the vehicle, a vehicle inside camera for imaging an inside of the vehicle, and a driver camera for imaging the driver. For example, the front camera, which images the area forward of the vehicle, transmits data indicating the captured image of the area forward of the vehicle as the detection data to the CAN communicator unit 12. For example, the vehicle inside camera transmits data indicating the captured image of the vehicle inside as the detection data to the CAN communicator unit 12. The multiple sensors 181 to 18n include, for example, a LIDAR (Light Detection and Ranging, Laser Imaging), a millimeter-wave radar, an ultrasonic sensor, an illuminance sensor, a rain sensor, etc. For example, the sensor for detecting an area forward of the vehicle, such as the LIDAR or the millimeter-wave radar, transmits data indicating a distance to a preceding vehicle as the detection data to the CAN communicator unit 12. For example, the illuminance sensor transmits data indicating illuminance as the detection data to the CAN communicator unit 12. For example, the rain sensor transmits data indicating a rainfall amount as the detection data to the CAN communicator unit 12.

The CAN communicator unit 12 is connected via the CAN bus 15 to a DSM (Driver Status Monitor) 19, a lane warning system 20, a lane keep system 21, an ACC (Adaptive Cruise Control) system 22, and other systems in a data communicable manner. For example, the DSM 19 transmits data indicating a driver's status as the detection data to the CAN communicator unit 12. For example, the lane warning system 20 transmits data indicating a control status of the lane warning system 20 as the detection data to the CAN communicator unit 12. For example, the lane keep system 21 transmits data indicating a control status of the lane keep system 21 as the detection data to the CAN communicator unit 12. For example, the ACC system 22 transmits data indicating a control status of the ACC system 22 as the detection data to the CAN communicator unit 12.

The number of CAN buses 13 to 15 connected to the CAN communicator unit 12 is not limited to three; it may be two or less, or four or more. A form in which various ECUs 161 to 16n, various cameras 171 to 17n, various sensors 181 to 18n, the DSM 19, and various systems 20 to 22 are connected to the CAN buses 13 to 15 may be any form. Various devices connected to the CAN bus 13 to 15 are not limited to the ECUs, the cameras, the sensors, and the systems described above. Furthermore, an in-vehicle communication network used is not limited to the CAN buses 13 to 15 but may be a configuration using Ethernet, etc. Ethernet is a registered trademark.

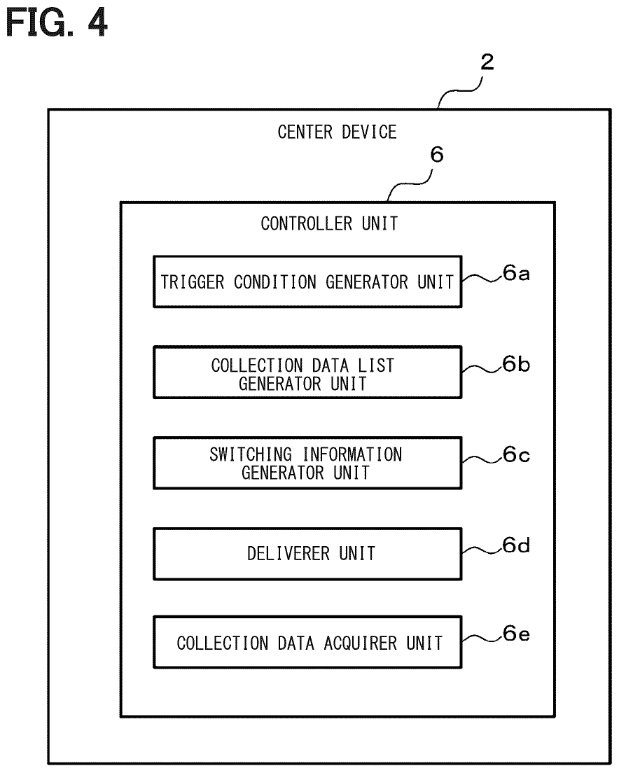

As shown in FIG. 4, on a function basis, the controller unit 6 in the center device 2 includes a trigger condition generator unit 6a, a collection data list generator unit 6b, a switching information generator unit 6c, a deliverer unit 6d, and a collection data acquirer unit 6e. These components 6a to 6e execute a data processing method of the center device 2 and execute a data processing program of the center device 2.

The trigger condition generator unit 6a generates multiple trigger conditions for detecting a scene where a user feels dissatisfaction (corresponding to a given scene of the vehicle). The collection data list generator unit 6b generates collection data lists corresponding to the multiple trigger conditions, respectively. The switching information generator unit 6c generates a switching condition and priority as switching information corresponding to each trigger condition and each collection data list. The deliverer unit 6d delivers the multiple trigger conditions generated by the trigger condition generator unit 6a, the collection data lists generated by the collection data list generator unit 6b, and the switching condition and priority generated by the switching information generator unit 6c from the communicator unit 7 to the vehicular device 4. The collection data acquirer unit 6e acquires the collection data from the vehicular device 4 by receiving, at the communicator unit 7, the data transmitted from the vehicular device 4.

There are two scenarios for switching between the trigger conditions and between the collection data lists: one where the center device 2 issues a switching command; the other where the vehicle issues a switching command. Each of the scenarios will be described.

### (1) When the Center Device 2 Issues a Switching Command

If the vehicular device 4 detects the switching command from the center device 2, the vehicular device 4 switches between the trigger conditions and between the collection data lists. Prior to the switching, the vehicular device 4 transmits simple data, such as vehicle speed and user operation when the ACC system 22 is off, to the center device 2. If the vehicular device 4 receives the switching command delivered from the center device 2 and detects the switching command from the center device 2, the vehicular device 4 then switches between logics and, after the switching, transmits the data to the center device 2 together with data on presence/absence of a nearby vehicle, etc. The following examples illustrate trigger condition IDs, collection data, switching conditions, and priorities.
“Trigger Condition (prior-to-switching)”,
ACC system control status: 1 (in operation),
Brake pedal operation amount: ≥1%,
“Collection Data (prior-to-switching)”,
p From 60 seconds prior to trigger condition establishment, latitude and longitude, vehicle speed, ACC system control status, and brake pedal operation amount,
“Trigger Condition (post-switching)”,
ACC system control status: 1 (in operation),
Brake pedal operation amount: ≥1%,
Vehicle-to-vehicle distance: ≤10 m,
“Collection Data (post-switching)”,
From 60 seconds prior to trigger condition establishment, latitude and longitude, vehicle speed, ACC system control status, brake pedal operation amount, presence/absence of nearby vehicle, and distance to nearby vehicles,
“Switching Condition and Priority”,
Trigger Condition A: High Priority,
Trigger Condition B: Low Priority.

### (2) When the Vehicle Issues a Switching Command

If the vehicular device 4 detects a switching command from the vehicle, the vehicular device 4 then switches between the trigger conditions and between the collection data lists. Prior to the switching, the vehicular device 4 transmits simple data, such as vehicle speed and user operation when the ACC system 22 is off for example, to the center device 2. If the vehicular device 4 detects a switching command from the vehicle, such as the driving mode changing from normal mode to eco mode, the vehicular device 4 then switches between logics, and after the switching, transmits the data to the center device 2 together with data on presence/absence of nearby vehicle, etc. The following examples illustrate the trigger conditions, the collection data, the switching condition, and the priorities.
“Trigger Condition (prior-to-switching)”,
ACC system control status: 1 (in operation),
Brake pedal operation amount: ≥1%,
“Collection Data (prior-to-switching)”,
From 60 seconds prior to trigger condition establishment, latitude and longitude, vehicle speed, ACC system control status, and brake pedal operation amount,
“Trigger Condition (post-switching)”,
ACC system control status: 1 (in operation),
Brake pedal operation amount: ≥1%,
Vehicle-to-vehicle distance: ≤10 m,
“Collection data (post-switching)”,
From 60 seconds prior to trigger condition establishment, latitude and longitude, vehicle speed, ACC system control status, brake pedal operation amount, presence/absence of nearby vehicle, and distance to nearby vehicle,
“Switching condition and Priority”,
Trigger Condition A: High Priority,
Trigger Condition B: Low Priority.

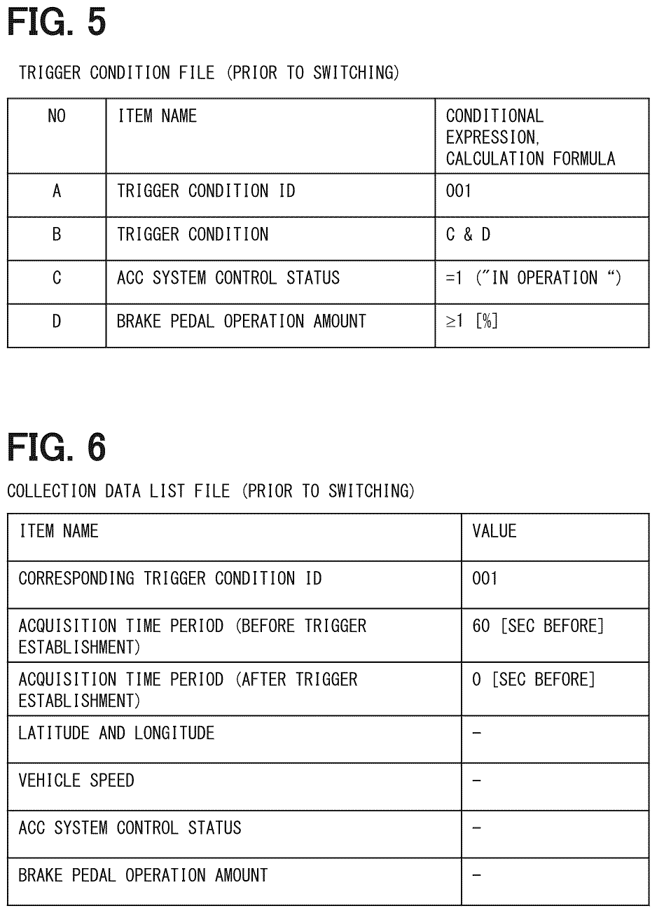

As shown in FIG. 5, the trigger condition generator unit 6a generates a trigger condition file for the prior-to-switching and generates the trigger condition for the prior-to-switching. The trigger condition file for the prior-to-switching shown in FIG. 5 includes the following items: trigger condition ID, trigger condition, ACC system control status, and brake pedal operation amount.

The collection data list generator unit 6b generates a collection data list corresponding to the trigger condition for the prior-to-switching. As shown in FIG. 6, the collection data list generator unit 6b generates a collection data list file for the prior-to-switching and generates a collection data list for the prior-to-switching. The collection data list for the prior-to-switching shown in FIG. 6 includes the following items: corresponding trigger condition ID, acquisition time period (before trigger establishment), acquisition time period (after trigger establishment), latitude and longitude, vehicle speed, ACC system control status, and brake pedal operation amount.

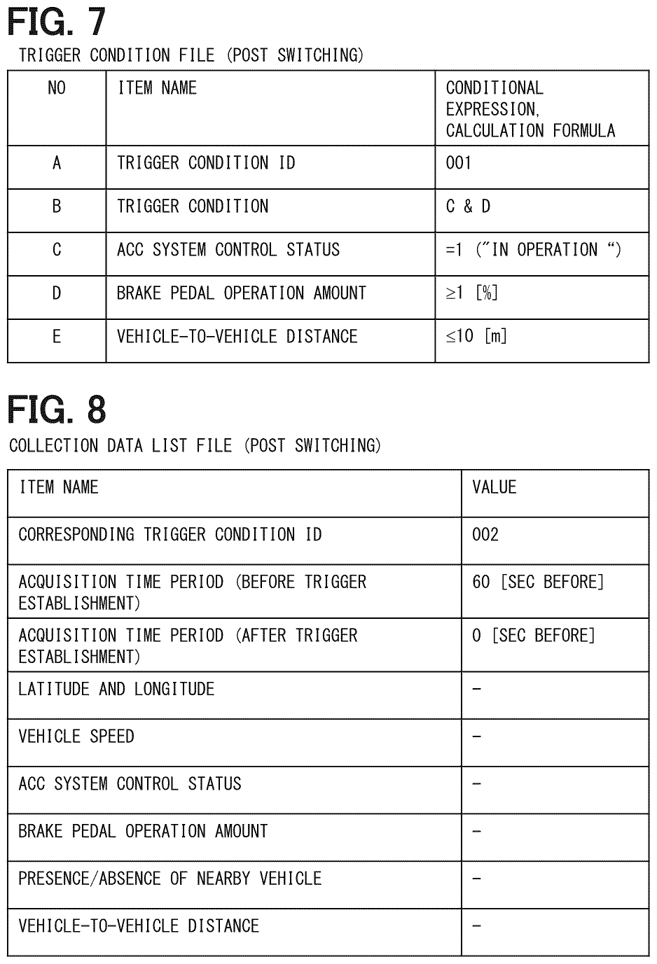

As shown in FIG. 7, the trigger condition generator unit 6a generates a trigger condition file for the post-switching and generates a trigger condition for the post-switching. The trigger condition file for the post-switching shown in FIG. 7 includes the following items: trigger condition ID, trigger condition, ACC system control status, brake pedal operation amount, and vehicle-to-vehicle distance.

The collection data list generator unit 6b generates a collection data list corresponding to the trigger condition for the post-switching. As shown in FIG. 8, the collection data list generator unit 6b generates a collection data list file for the post-switching and generates a collection data list for the post-switching. The collection data list for the post-switching shown in FIG. 8 includes the following items: corresponding trigger condition ID, acquisition time period (before trigger establishment), acquisition time period (after trigger establishment), latitude and longitude, vehicle speed, ACC system control status, brake pedal operation amount, presence/absence of nearby vehicle, and vehicle-to-vehicle distance.

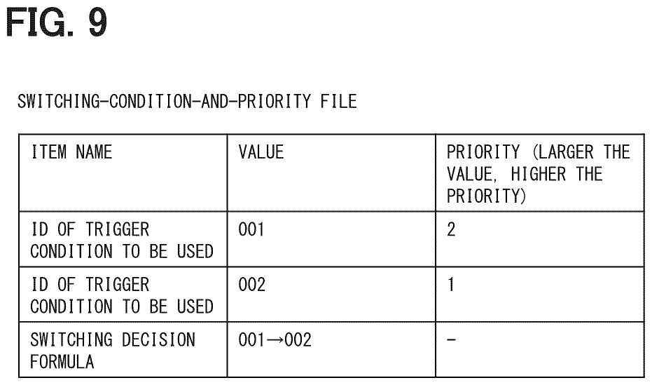

As shown in FIG. 9, the switching information generator unit 6c generates a switching-condition-and-priority file and generates the switching condition and the priority. The switching-condition-and-priority file shown in FIG. 9 includes the following items: the trigger condition ID of the trigger condition to be used; and switching decision formula. The priorities and the switching decision formula are set so that no conflicts arise. In case the setting causes a conflict to occur: the priority is preferentially used over the switching decision formula; the trigger condition determination is performed according to the trigger condition having the highest priority; and thereafter, the trigger condition switching is made according to the switching decision formula.

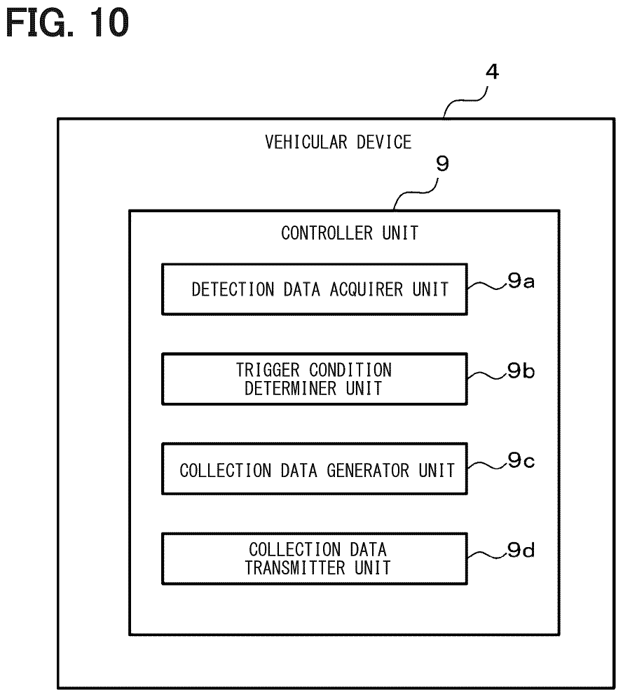

As shown in FIG. 10, on a function basis, the controller unit 9 of the vehicular device 4 includes a detection data acquirer unit 9a, a trigger condition determiner unit 9b, a collection data generator unit 9c, and a collection data transmitter unit 9d. These components 9a to 9d execute a data processing method of the vehicular device 4 and execute a data processing program of the vehicular device 4.

The detection data acquirer unit 9a acquires the detection data required for the trigger condition determination. In the case of determining the control status of the ACC system 22 for example, the detection data acquirer unit 9a acquires data indicating the control status of the ACC system 22 as the detection data from the ACC system 22.

The trigger condition determiner unit 9b is able to switch the trigger condition to be used according to the switching condition or the priority. In response to the detection data acquirer unit 9a acquiring the detection data, the trigger condition determiner unit 9b performs the trigger condition determination based on the acquired detection data according to the trigger condition. The collection data generator unit 9c is able to switch the collection data list to be used according to the switching condition or the priority and generates the collection data based on a determination result of the trigger condition determination. In response to the collection data generator unit 9c generating the collection data, the collection data transmitter unit 9d transmits the generated collection data to the center device 2 via the communicator unit 10.

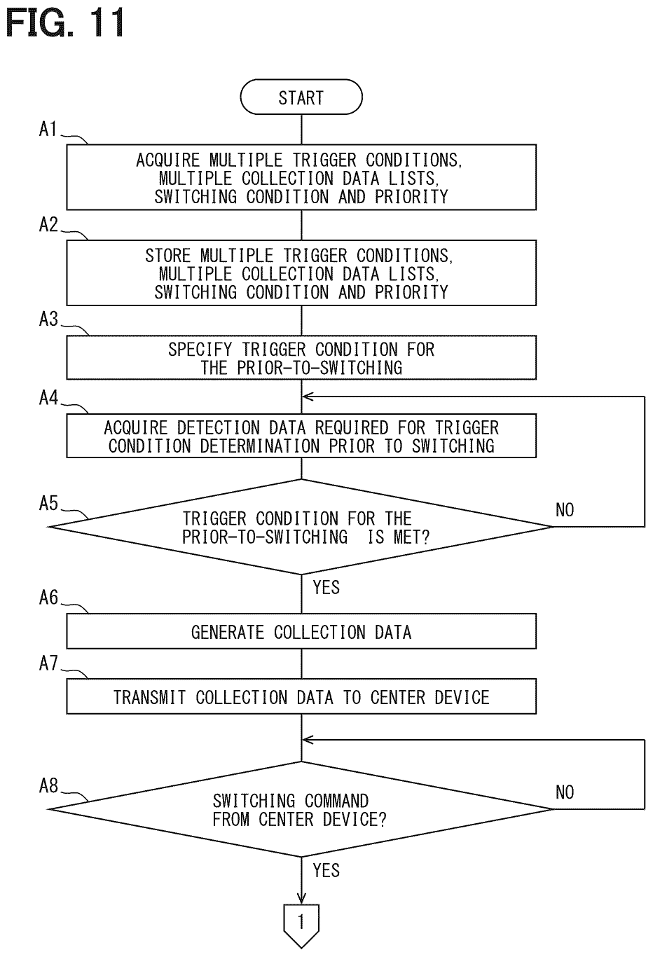

Operations of the above configuration will be described with reference to FIG. 11 to FIG. 18. Now, the operations performed by the controller unit 9 of the vehicular device 4 and the operations performed by the controller unit 6 of the center device 2 in cases where the center device 2 issues a switching command and where the vehicular device issues a switching command will be described.

### (1) When the Center Device 2 Issues a Switching Command

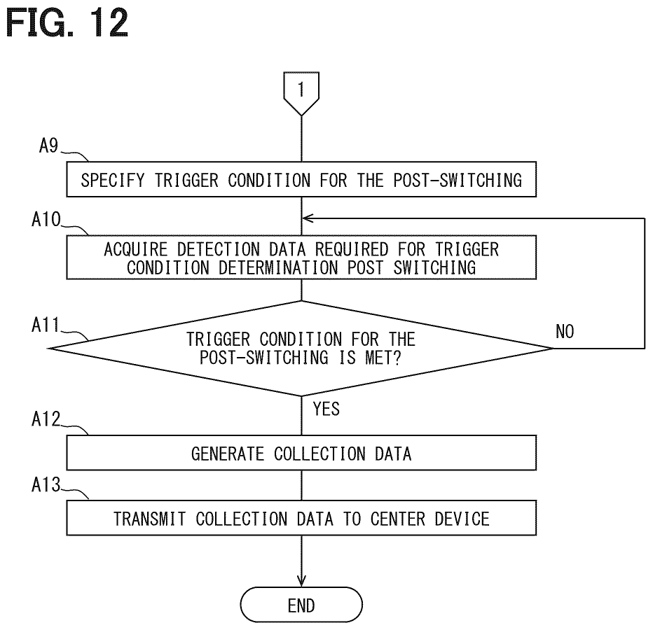

### (1-1) Processes Performed by the Controller Unit 9 of the Vehicular Device 4 (See FIG. 11 and FIG. 12).

In the vehicular device 4, the controller unit 9 starts a vehicle-side process and waits to receive the multiple trigger conditions, the multiple collection data lists, the switching condition and the priority from the center device 2. Upon receiving, at the communicator unit 10, the multiple trigger conditions, the multiple collection data lists, the switching condition, and the priority transmitted from the center device 2, the controller unit 9 acquires the multiple trigger conditions, the multiple collection data lists, the switching condition, and the priority from the center device 2 (A1), and stores the acquired multiple trigger conditions and multiple collection data lists in preparation for switching between the trigger conditions and between the collection data lists (A2).

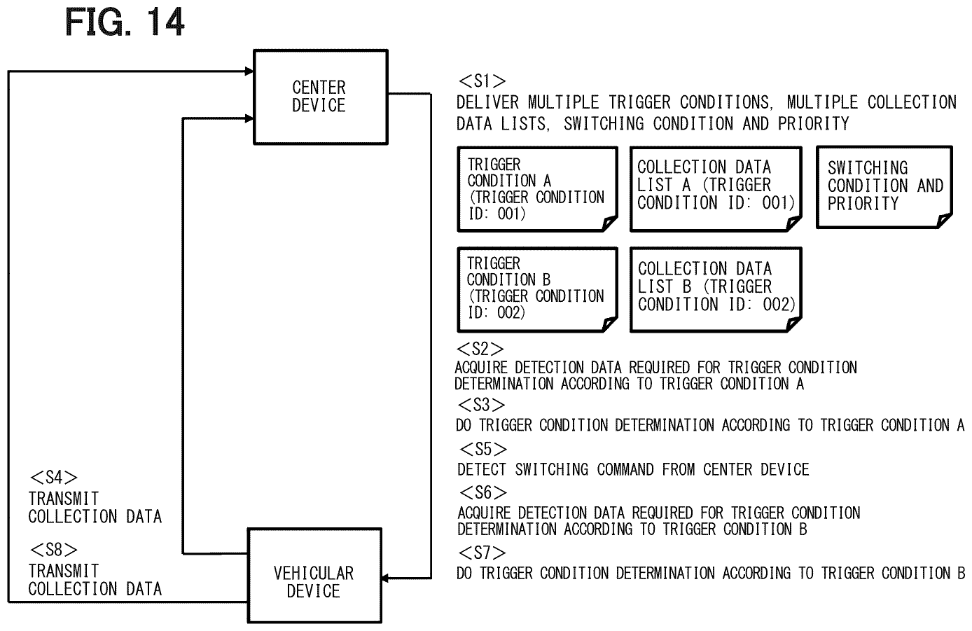

The controller unit 9 specifies the trigger condition to be used first, specifically, the trigger condition with the highest priority, as the trigger condition for the prior-to-switching (A3), and acquires the detection data required for the trigger condition determination for the prior-to-switching (A4, S2 in FIG. 14, corresponding to a detection data acquisition procedure). The controller unit 9 determines whether the trigger condition for the prior-to-switching is met (A5, S3 in FIG. 14, corresponding to a trigger condition determination procedure). If the controller unit 6 determines that the trigger condition for the prior-to-switching is met (A5: YES), the controller unit 6 then generates the collection data (A6, corresponding to a collection data generation procedure) and transmits the generated collection data from the communicator unit 10 to the center device 2 (A7, S4 in FIG. 14, corresponding to a collection data transmission procedure).

The controller unit 9 waits to receive a switching command from the center device 2. If the controller unit 9 detects the switching command from the center device 2 by receiving, at the communicator unit 10, the switching command transmitted from the center device 2 (A8: YES, S5 in FIG. 14), the controller unit 9 specifies the trigger condition with the next-highest priority as the trigger condition for the post-switching (A9) and acquires the detection data required for the specified post-switching trigger condition determination (A10, S6 in FIG. 14, corresponding to a detection data acquisition procedure). The controller unit 9 determines whether the trigger condition for the post-switching is met (A11, S7 in FIG. 14, corresponding to a trigger condition determination procedure). If the controller unit 6 determines that the trigger condition for the post-switching is met (A11: YES), the controller unit 6 then generates the collection data (A12, corresponding to a collection data generation procedure), transmits the generated collection data from the communicator unit 10 to the center device 2 (A13, S8 in FIG. 14, corresponding to a collection data transmission procedure), and ends the vehicle-side process.

Regarding the above-illustrated the trigger condition (prior-to-switching), the controller unit 9 determines that the trigger condition for the prior-to-switching is met if the following is met:
ACC system control status: 1 (in operation), and
Brake pedal travel: ≥1%.

Specifically, where the ACC system is in operation, if the user performs the brake pedal operation with the brake pedal operation amount of 1% or more, the controller unit 9 determines that the trigger condition for the prior-to-switching is met. The controller unit 9 generates the collection data including, from 60 seconds prior to the trigger condition establishment, the latitude and longitude, the vehicle speed, the control status of the ACC system, and the brake pedal operation amount, and transmits this collection data to the center device 2 via the communicator unit 10.

Regarding the above-illustrated the trigger condition (post switching), upon detecting the switching command from the center device 2, the controller unit 9 determines that the trigger condition for the post-switch over is met if the following is met:
acc system control status: 1 (in operation),
Brake pedal travel: ≥1%, and
Vehicle-to-vehicle distance: ≤10 m.

Specifically, where the ACC system is in operation and the vehicle-to-vehicle distance is 10 meters or less, if the user performs the brake pedal operation with the brake pedal operation amount of 1% or more, the controller unit 9 determines that the trigger condition for the post-switching is met. The controller unit 9 generates the collection data including, from 60 seconds prior to the trigger condition establishment, the latitude and longitude, the vehicle speed, the control status of the ACC system, the brake pedal operation amount, the presence/absence of nearby vehicle, and the distance to the nearby vehicle, and transmits this collection data to the center device 2 via the communicator unit 10.

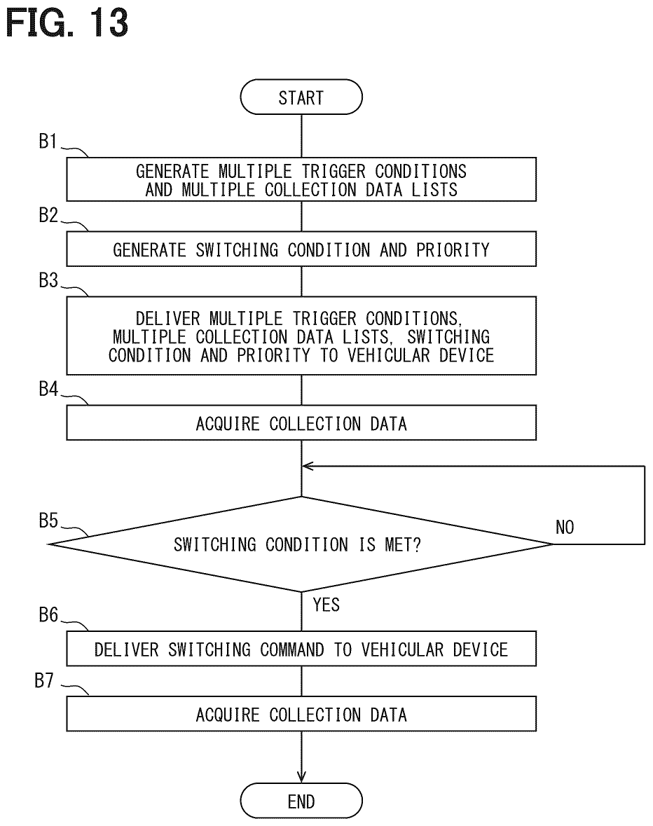

### (1-2) Processes Performed by the Controller Unit 6 of the Center Device 2 (see FIG. 13).

In the center device 2, upon start of the center-side process, the controller unit 6 generates the multiple trigger conditions and the multiple collection data lists (B1, corresponding to a trigger condition generation procedure and a collection data list generation procedure), generates the switching condition and the priority (B2, corresponding to a switching information generation procedure), transmits the multiple trigger conditions, the multiple collection data lists, the switching condition and the priority from the communicator unit 7 to the vehicular device 4 (B3, S1 in FIG. 14, corresponding to a transmission procedure), and waits to receive the collection data from the vehicular device 4. Upon the communicator unit 10 receiving the collection data transmitted from the vehicular device 4, the controller unit 6 acquires the collection data from the vehicular device 4 (B4; corresponding to a collection data acquisition procedure).

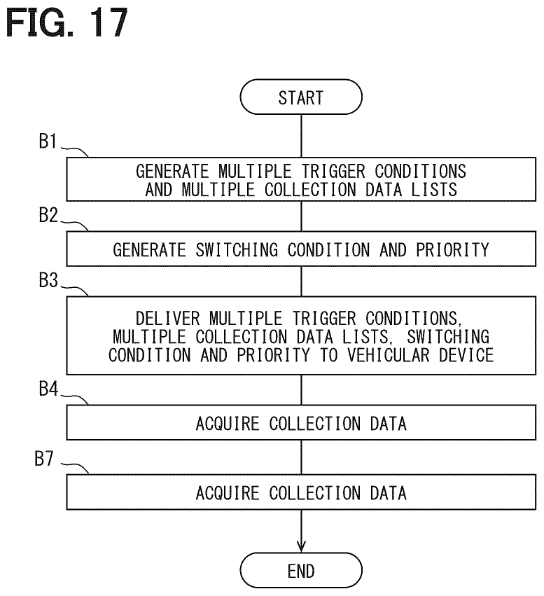

If the controller unit 6 determines that a switching condition in the center device 2 is met (B5; YES), the controller unit 6 causes the communicator unit 7 to deliver the switching command to the vehicular device 4 (B6, S2 in FIG. 17) and waits to receive the collection data from the vehicular device 4. Upon the communicator unit 10 receiving the collection data transmitted from the vehicular device 4, the controller unit 6 acquires the collection data from the vehicular device 4 (B7, corresponding to a collection data acquisition procedure) and ends the center-side process. After that, the collection data acquired from the vehicular device 4 may be analyzed and thereby the scene where the felt the dissatisfaction may be analyzed.

### (2) When the Vehicle Issues a Switching Command

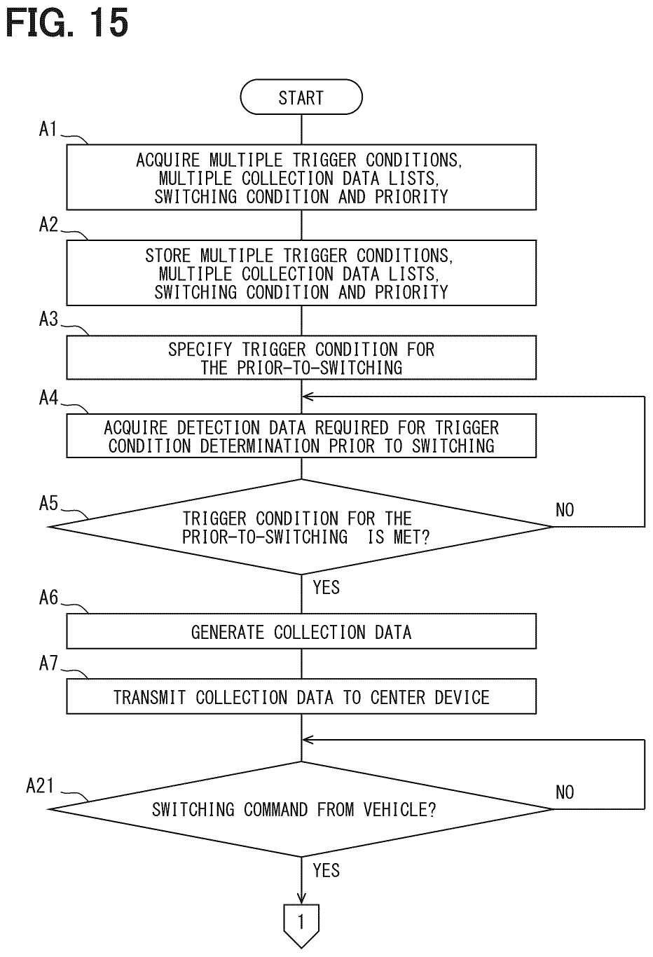

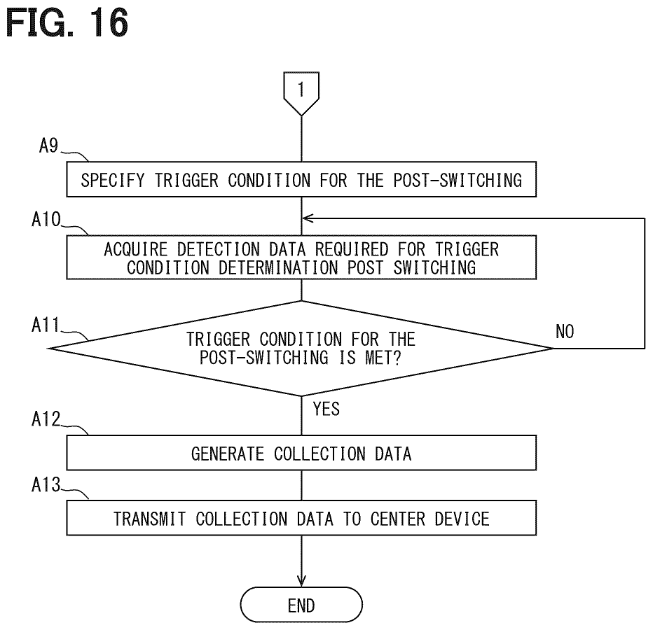

(2-1) Processes Performed by the Controller Unit 9 of the Vehicular device 4 (see FIG. 15 and FIG. 16).

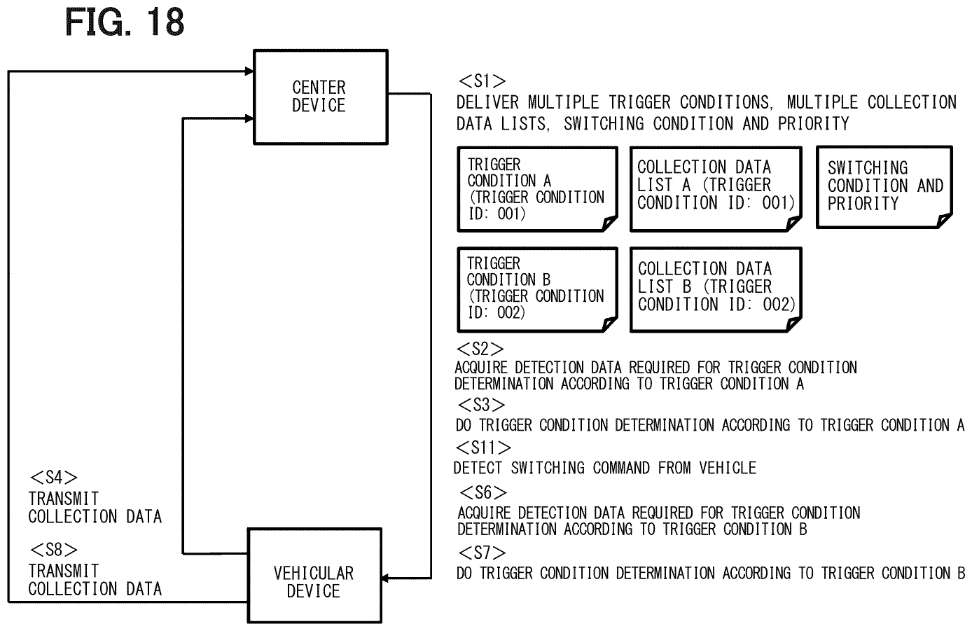

In the vehicular device 4, upon start of the vehicle-side process, the controller unit 9 performs the above-described steps A1 to A7. If the controller unit 9 detects the switching command from the vehicle (A21: YES, S11 in FIG. 18), the controller unit 9 then performs the steps A9 to A13 described above and ends the vehicle-side process. (2-2) Processes performed by the controller unit 6 of the center device 2 (see FIG. 17).

In the center device 2, upon start of the center-side process, the controller unit 6 performs the steps B1 to B4 described above. After the vehicular device 4 switches between the trigger conditions and between the collection data lists, the controller unit 6 acquires the collection data from the vehicular device 4 by receiving, at the communicator unit 10, the collection data transmitted from the vehicular device 4 (B7, corresponding to a collection data acquisition procedure), and ends the center-side process.

The above examples illustrate generating both the switching condition and the priority. Alternatively, either the switching condition or the priority may be generated. The above examples illustrate performing both switching between the trigger conditions and switching between the collection data lists. Alternatively, according to the switching condition or the priority, either switching between the trigger conditions or switching between the collection data lists may be performed.

In a configuration able to switch only the trigger condition to be used, the trigger condition generator unit 6a in the center device 2 generates the multiple trigger conditions for detecting a given scene of the vehicle. The collection data list generator unit 6b generates a collection data list corresponding to the multiple trigger conditions. The switching information generator unit 6c generates the switching condition and/or priority corresponding to each trigger condition. The deliverer unit 6d delivers the multiple trigger conditions, the collection data list, and the switching condition and/or the priority to the vehicular device 4. In the vehicular device 4, the trigger condition determiner unit 9b is able to switch the trigger condition to be used according to the switching condition and/or the priority and the trigger condition determiner unit 9b performs the trigger condition determination based on the detection data according to the trigger condition. The collection data generator unit 9c generates the collection data based on a determination result of the trigger condition evaluation. Upon switching the trigger condition to be used, the vehicular device 4 may transmit the ID of the post switching trigger condition to the center device 2 as a notification of the trigger condition currently used by the vehicular device or the vehicular device 4 may transmit the collection data to the center device 2 together with the ID of the used trigger condition.

In a configuration able to switch only the collection data list to be used, the trigger condition generator unit 6a in the center device 2 generates a trigger condition for detecting a given scene of the vehicle. The collection data list generator unit 6b generates multiple collection data lists corresponding to the trigger condition. The switching information generator unit 6c generates the switching condition and/or the priority corresponding to each collection data list. The deliverer unit 6d delivers the trigger condition, the multiple collection data lists, and the switching condition and/or the priority to the vehicular device 4. In the vehicular device 4, the trigger condition determiner unit 9b performs the trigger condition determination based on the detection data according to the trigger condition. The collection data generator unit 9c is able to switch the collection data list to be used according to the switching condition and/or the priority and the trigger condition determiner unit 9b generates the collection data based on a determination result of the trigger condition determination. Furthermore, upon switching the collection data list to be used, the vehicular device 4 may transmit the ID of the post-switching collection data list to the center device 2 as a notification of the collection data list currently-used by the vehicular device 4 or the vehicular device 4 may transmit the collection data to the center device 2 together with the ID of the used collection data list.

The above-described embodiments provide the following operational effects. The center device 2 generates the switching condition and the priority corresponding to each trigger condition and each collection data list and the vehicular device 4 switches between the trigger conditions and between the collection data lists according to the switching condition and the priority, generates the collection data based on a determination result of the trigger condition determination and transmits the collection data to the center device 2. It is possible to flexibly switch between the plurality of trigger conditions for detecting a scene where a user feels dissatisfaction, thereby enabling efficient improvement to vehicle functionality.

The trigger condition and the collection data list to be used are switched according to the switching command from the center device 2. The trigger condition and the collection data list to be used are switchable due to the center device 2 side convenience.

The trigger condition and the collection data list to be used are switched according to the switching command from the vehicle. The trigger condition and the collection data list to be used are switchable due to the vehicle side convenience.

While the present disclosure has been described with reference to embodiments thereof, it is to be understood that the disclosure is not limited to the embodiments and constructions. The present disclosure also encompasses various modifications and variations within equivalents. Additionally, various combinations and configurations, as well as other combinations and configurations, including only a single element, more, or less, are within the scope and spirit of the present disclosure.

The controller units and methods thereof described in the present disclosure may be implemented by a special purpose computer provided by configuring a memory and processor programmed to perform one or more functions embodied in a computer program. Alternatively, the controller units and methods thereof described in the present disclosure may be implemented by a special purpose computer provided by configuring a processor with one or more dedicated hardware logic circuits. Alternatively, the controller units and methods thereof described in the present disclosure may be implemented by one or more special purpose computers provided by configuring a memory and processor programmed to perform one or more functions in combination with configuring a processor with one or more hardware logic circuits. The computer program may be stored in a computer-readable non-transitory tangible storage medium as instructions executed by a computer.

In addition to the claims, the present disclosure encompasses the following.
[1]. A data communication system (1) comprises a center device (2) and a vehicular device (4) mounted on a vehicle which are capable of data communication with each other,
   the center device including:
   a trigger condition generator unit (6a) that generates a plurality of trigger conditions for detecting a given scene of the vehicle;
   a collection data list generator unit (6b) that generates a plurality of collection data lists corresponding to the plurality of trigger conditions, respectively;
   a switching information generator unit (6c) that generates a switching condition and/or priority corresponding to each trigger condition and each collection data list;
   a deliverer unit (6d) that delivers the plurality of trigger conditions and the plurality of collection data lists to the vehicular device, and delivers the switching condition and/or the priority to the vehicular device; and
   a data acquirer unit (6e) that acquires collection data indicated in the collection data list from the vehicular device,
   the vehicular device including:
   a detection data acquirer unit (9a) that acquires detection data required for a trigger condition determination;
   a trigger condition determiner unit (9b) that is able to switch a trigger condition to be used according to the switching condition and/or the priority, and performs the trigger condition determination based on the detection data according to the trigger condition;
   a collection data generator unit (9c) that is able to switch a collection data list to be used according to the switching condition and/or the priority, and generates the collection data based on a determination result of the trigger condition determination; and
   a collection data transmitter unit (9d) that transmits the collection data to the center device.
[2]. In the data communication system according to [1]:
   according to a switching command from the center device, the trigger condition determiner unit switches the trigger condition to be used; and
   according to a switching command from the center device, the collection data generator unit switches the collection data list to be used.
[3]. In the data communication system according to [1] or [2]:
   according to a switching command from the vehicle, the trigger condition determiner unit switches the trigger condition to be used; and
   according to a switching command from the vehicle, the collection data generator unit switches the collection data list to be used.
[4]. In the data communication system according to any one of [1] to [3]:
   even when the trigger condition determiner unit does not switch the trigger condition to be used, the collection data generator unit switches the collection data list to be used according to the switching condition and/or the priority.
[5]. A data communication system (1) comprises a center device (2) and a vehicular device (4) mounted on a vehicle which are capable of data communication with each other,
   the center device including:
   a trigger condition generator unit (6a) that generates a plurality of trigger conditions for detecting a given scene of the vehicle;
   a collection data list generator unit (6b) that generates a collection data list corresponding to the plurality of trigger conditions;
   a switching information generator unit (6c) that generates a switching condition and/or priority corresponding to each trigger condition;
   a deliverer unit (6d) that delivers the plurality of trigger conditions and the collection data list to the vehicular device, and delivers the switching condition and/or the priority to the vehicular device; and
   a data acquirer unit (6e) that acquires collection data indicated in the collection data list from the vehicular device,
   the vehicular device including:
   a detection data acquirer unit (9a) that acquires detection data required for a trigger condition determination;
   a trigger condition determiner unit (9b) that is able to switch a trigger condition to be used according to the switching condition and/or the priority, and performs the trigger condition determination based on the detection data according to the trigger condition;
   a collection data generator unit (9c) that generates the collection data based on a determination result of the trigger condition determination; and
   a collection data transmitter unit (9d) that transmits the collection data to the center device.
[6]. A data communication system (1) comprises a center device (2) and a vehicular device (4) mounted on a vehicle which are capable of data communication with each other,
   the center device including:
   a trigger condition generator unit (6a) that generates a trigger condition for detecting a given scene of the vehicle;
   a collection data list generator unit (6b) that generates a plurality of collection data lists corresponding to the trigger condition;
   a switching information generator unit (6c) that generates a switching condition and/or priority corresponding to each collection data list;
   a deliverer unit (6d) that delivers the trigger condition and the plurality of collection data lists to the vehicular device, and delivers the switching condition and/or the priority to the vehicular device; and
   a data acquirer unit (6e) that acquires collection data indicated in the collection data list from the vehicular device,
   the vehicular device including:
   a detection data acquirer unit (9a) that acquires detection data required for a trigger condition determination;
   a trigger condition determiner unit (9b) that performs the trigger condition determination based on the detection data according to the trigger condition;
   a collection data generator unit (9c) that is able to switch a collection data list to be used according to the switching condition and/or the priority, and generates the collection data based on a determination result of the trigger condition determination; and
   a collection data transmitter unit (9d) that transmits the collection data to the center device.

What is claimed is:

1. A data communication system comprising
a center device and a vehicular device mounted on a vehicle which are capable of data communication with each other,
the center device including at least one processor that executes a program stored in a memory and/or at least one dedicated circuit, implementing:
a trigger condition generator configured to generate a plurality of trigger conditions for detecting a given scene of the vehicle;
a collection data list generator configured to generate a collection data list corresponding to the plurality of trigger conditions;
a switching information generator configured to generate a switching condition and/or priority corresponding to each trigger condition;
a deliverer configured to deliver the plurality of trigger conditions and the collection data list to the vehicular device, and deliver the switching condition and/or the priority to the vehicular device; and
a data acquirer configured to acquire collection data indicated in the collection data list from the vehicular device,
the vehicular device including at least one processor that executes a program stored in a memory and/or at least one dedicated circuit, implementing:
a detection data acquirer configured to acquire detection data required for a trigger condition determination;
a trigger condition determiner configured to switch a trigger condition to be used according to the switching condition and/or the priority, and perform the trigger condition determination based on the detection data according to the trigger condition;
a collection data generator configured to generate the collection data based on a determination result of the trigger condition determination; and
a collection data transmitter configured to transmit the collection data to the center device.

2. A center device capable of data communication with a vehicular device mounted on a vehicle,
wherein the vehicular device is configured to acquire detection data required for a trigger condition determination, switch a trigger condition to be used according to a switching condition and/or priority, perform the trigger condition determination based on the detection data according to the trigger condition, generate collection data based on a determination result of the trigger condition determination, transmit the collection data to the center device,
the center device comprising at least one processor that executes a program stored in a memory and/or at least one dedicated circuit, implementing:
a trigger condition generator configured to generate a plurality of trigger conditions for detecting a given scene of the vehicle;
a collection data list generator configured to generate the collection data list corresponding to the plurality of trigger conditions;
a switching information generator configured to generate the switching condition and/or priority corresponding to each trigger condition;
a deliverer configured to deliver the plurality of trigger conditions and the collection data list to the vehicular device, and delivers the switching condition and/or the priority to the vehicular device; and
a data acquirer configured to acquire the collection data indicated in the collection data list from the vehicular device.

3. A vehicular device mounted on a vehicle and capable of data communication with a center device,
wherein the center device is configured to generate a plurality of trigger conditions for detecting a given scene of the vehicle, generate a collection data list corresponding to the plurality of trigger conditions, generate a switching condition and/or priority corresponding to each trigger condition, deliver the plurality of trigger conditions and the collection data list to the vehicular device, deliver the switching condition and/or the priority to the vehicular device, and acquire collection data indicated in the collection data list from the vehicular device,
the vehicular device comprising at least one processor that executes a program stored in a memory and/or at least one dedicated circuit, implementing:
a detection data acquirer configured to acquire detection data required for a trigger condition determination;
a trigger condition determiner configured to switch a trigger condition to be used according to the switching condition and/or the priority, and perform the trigger condition determination based on the detection data according to the trigger condition;
a collection data generator configured to generate the collection data based on a determination result of the trigger condition determination; and
a collection data transmitter configured to transmit the collection data to the center device.

4. A data processing method executed in a data communication system in which a center device and a vehicular device mounted on a vehicle are capable of data communication with each other,
the data processing method comprising executing in the center device:
generating a plurality of trigger conditions for detecting a given scene of the vehicle;
generating a collection data list corresponding to the plurality of trigger conditions;
generating a switching condition and/or priority corresponding to each trigger condition;
delivering the plurality of trigger conditions and the collection data list to the vehicular device, and delivering the switching condition and/or the priority to the vehicular device; and
acquiring collection data indicated in the collection data list from the vehicular device,
the data processing method further comprising executing in the vehicular device:
acquiring detection data required for a trigger condition determination;
switching a trigger condition to be used according to the switching condition and/or the priority, and performing the trigger condition determination based on the detection data according to the trigger condition;
generating the collection data based on a determination result of the trigger condition determination; and
transmitting the collection data to the center device.

5. A data processing method executed in a center device capable of data communication with a vehicular device mounted on a vehicle,
wherein the vehicular device is configured to acquire detection data required for a trigger condition determination, switch a trigger condition to be used according to a switching condition and/or priority, perform the trigger condition determination based on the detection data according to the trigger condition, generate collection data based on a determination result of the trigger condition determination, transmit the collection data to the center device,
the data processing method comprising executing in the center device:
generating a plurality of trigger conditions for detecting a given scene of the vehicle;
generating a collection data list corresponding to the plurality of trigger conditions;
generating a switching condition and/or priority corresponding to each trigger condition;
delivering the plurality of trigger conditions and the collection data list to the vehicular device, and delivering the switching condition and/or the priority to the vehicular device; and
acquiring the collection data indicated in the collection data list from the vehicular device.

6. A data processing method executed in a vehicular device mounted on a vehicle and capable of data communication with a center device,
wherein the center device generates a plurality of trigger conditions for detecting a given scene of the vehicle, generates a collection data list corresponding to the plurality of trigger conditions, generates a switching condition and/or priority corresponding to each trigger condition, delivers the plurality of trigger conditions and the collection data list to the vehicular device, delivers the switching condition and/or the priority to the vehicular device, and acquires collection data indicated in the collection data list from the vehicular device,
the data processing method comprising executing in the vehicular device:
acquiring detection data required for a trigger condition determination;
switching a trigger condition to be used according to the switching condition and/or the priority, and performing the trigger condition determination based on the detection data according to the trigger condition;
generating the collection data based on a determination result of the trigger condition determination; and
transmitting the collection data to the center device.

7. A data processing program stored in a non-transitory storage medium for a center device capable of data communication with a vehicular device mounted on a vehicle,
wherein the vehicular device is configured to acquire detection data required for a trigger condition determination, switch a trigger condition to be used according to a switching condition and/or priority, perform the trigger condition determination based on the detection data according to the trigger condition, generate collection data based on a determination result of the trigger condition determination, transmit the collection data to the center device,
the data processing program causing the center device to execute:
generating a plurality of trigger conditions for detecting a given scene of the vehicle;
generating a collection data list corresponding to the plurality of trigger conditions;
generating a switching condition and/or priority corresponding to each trigger condition;
delivering the plurality of trigger conditions and the collection data list to the vehicular device, and delivering the switching condition and/or the priority to the vehicular device; and
acquiring the collection data indicated in the collection data list from the vehicular device.

8. A data processing program stored in a non-transitory storage medium for a vehicular device mounted on a vehicle and capable of data communication with a center device,
wherein the center device generates a plurality of trigger conditions for detecting a given scene of the vehicle, generates a collection data list corresponding to the plurality of trigger conditions, generates a switching condition and/or priority corresponding to each trigger condition, delivers the plurality of trigger conditions and the collection data list to the vehicular device, delivers the switching condition and/or the priority to the vehicular device, and acquires collection data indicated in the collection data list from the vehicular device,
the data processing program causing the vehicular device to execute:
acquiring detection data required for a trigger condition determination;
switching a trigger condition to be used according to the switching condition and/or the priority, and performing the trigger condition determination based on the detection data according to the trigger condition;
generating the collection data based on a determination result of the trigger condition determination; and
transmitting the collection data to the center device.
